(19) United States
(12) Patent Application Publication
(10) Pub. No.: US 2016/0048650 A1
(43) Pub. Date: Feb. 18, 2016

(54) Automated Medical Matrix for Diagnosing and Scheduling Patients

(71) Applicant: Julian Omidi, Los Angeles, CA (US)

(72) Inventor: Julian Omidi, Los Angeles, CA (US)

(21) Appl. No.: 14/823,931

(22) Filed: Aug. 11, 2015

Related U.S. Application Data
(63) Continuation of application No. 13/341,923, filed on Dec. 31, 2011, now abandoned.
(60) Provisional application No. 61/428,993, filed on Dec. 31, 2010.

(51) Int. Cl. G06F 19/00

(52) U.S. Cl. CPC G06F 19/345; G06F 19/325; G06F 19/366; G06F 19/327; G06F 19/328

(57) ABSTRACT

The present invention is comprised of an automated medical matrix for diagnosing and scheduling patients for providing automated treatment selection cross referenced to a diagnosis, ordering, scheduling and insurance health plan pre-approvals within a medical center such as a surgery center or hospital. The present invention is further comprised of an automated treatment outcome results scoring system to rank the most effective treatment available being used in a medical center. The present invention is further comprised of modules that automatically coordinates treatment appointments between various medical center departments and automatically completes forms preparations for ordering the treatment, get insurance plan pre-approvals and billing processes to reduce staff time to perform the same tasks manually and increase effective treatment selection, shorten patient waiting time for treatments and reduce liability risk of poorly selected treatments.

The present application is a continuation of U.S. patent application Ser. No. 13/341,923 filed Dec. 31, 2011, which claims priority to U.S. Provisional Application Ser.No.: 61/428,993 filed Dec. 31, 2010, each of which are incorporated by reference herein in their entirety.

### BACKGROUND

Medical centers such as surgery centers and hospitals have relied for the most part on the experience and training of medical personnel to determine which treatments are best for a particular patient with a specific diagnosis. The same medical personnel must use their time to contact multiple departments within the medical center to find available appointment to book a patient for the treatment or procedure. In the busy work environment they are to also notify the accounting department to check on whether a patient insurance plan will cover the proposed treatment and then reply to the medical personnel whether they can proceed with the treatment as scheduled. These manual processes can take many hours or even days before a patient can receive some type of treatment for their condition. The medical personnel must find time to get additional periodic training on best treatments of a diagnosis. The insurance plan approval process can get delayed due to missing information or erroneous information. The medical center may face a higher risk of liability due to poor selection of treatment choices. The patient may suffer longer periods of time due to limited or unsuccessful treatments and face repeated trial and error treatment protocols. Automating the entire process with up to date effective treatment choices will save medical personnel time, get the patient effective treatment faster and better coordinate scheduling between departments.

### BRIEF DESCRIPTION OF THE WINGS

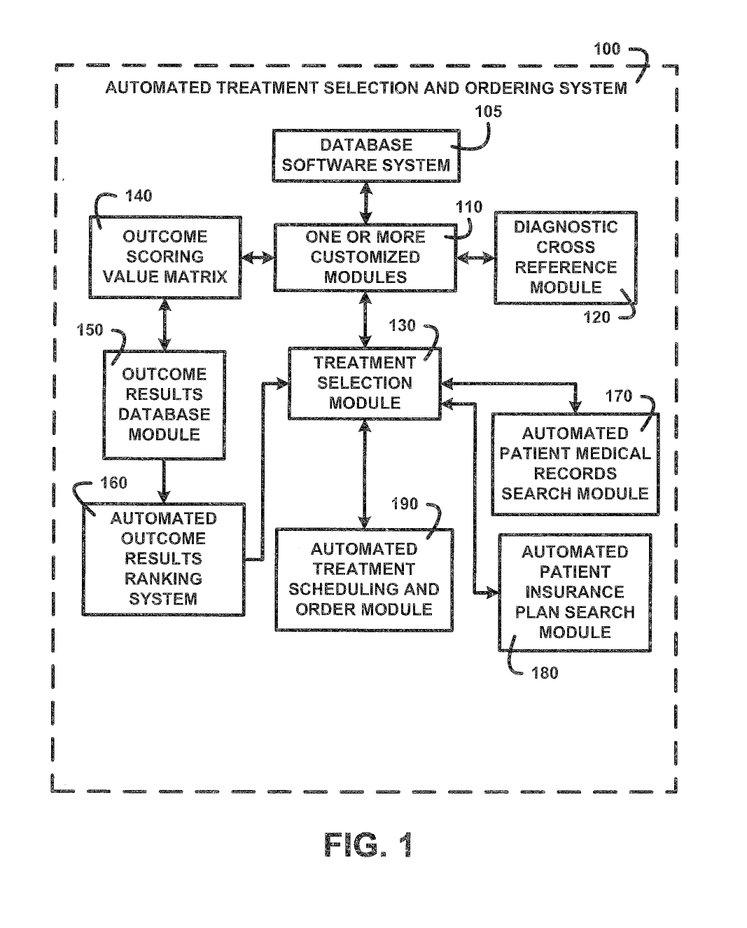

FIG. 1 shows a block diagram of an overview of an automated medical matrix for diagnosing and scheduling patients of one embodiment of the present invention.

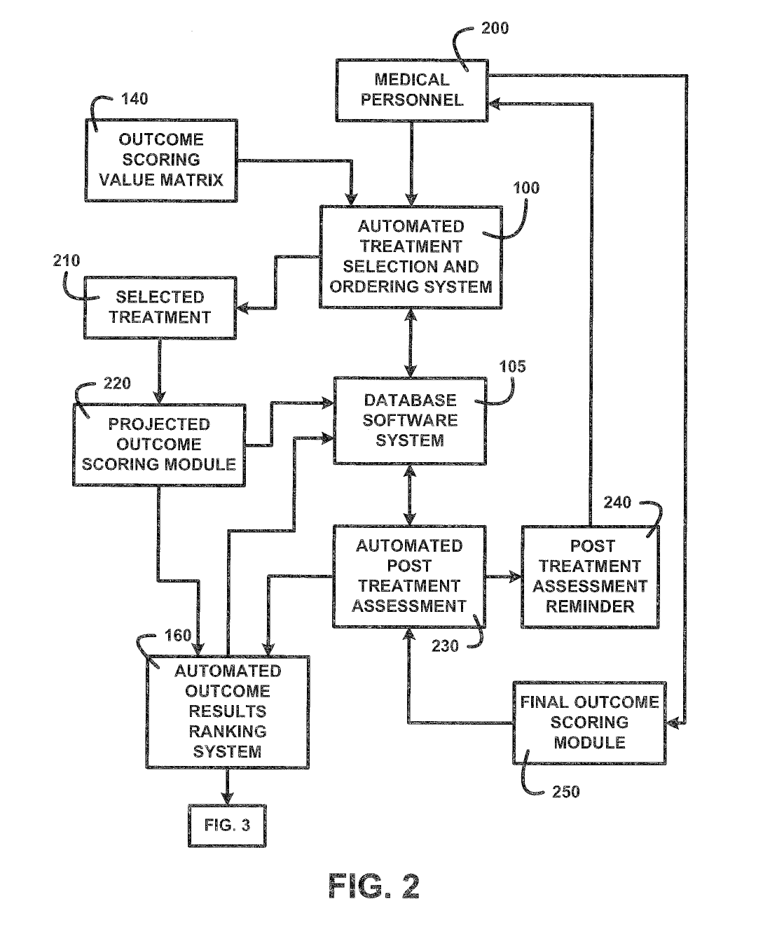

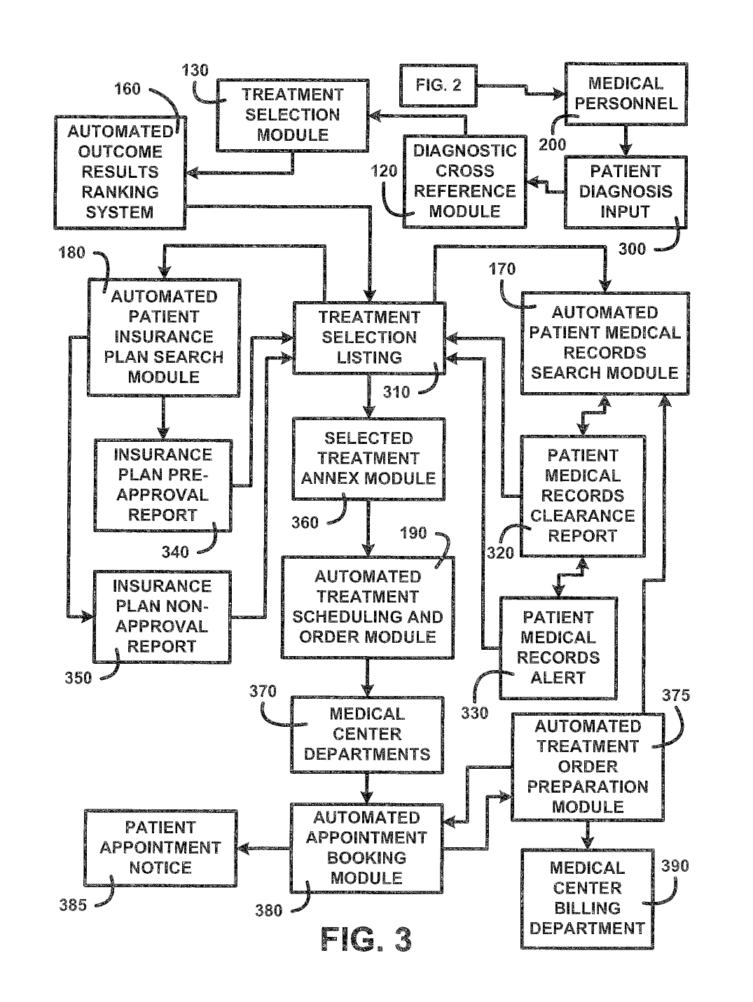

FIG. 2 shows a block diagram of an overview flow chart of an automated medical matrix for diagnosing and scheduling patients process and continues on FIG. 3 of one embodiment of the present invention.

FIG. 3 shows a block diagram of an overview flow chart continuing from FIG. 2 of an automated medical matrix for diagnosing and scheduling patients of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of an automated medical matrix for diagnosing and scheduling patients is described for illustrative purposes and the underlying system can apply to all types of diagnostic categories and treatment types. In this description the terms treatment shall mean any application of the medical arts whether for example it could be classified as a procedure such as an invasive surgery or a non-invasive treatment to a person or taking a medication or following a regimen such as a special diet. In one embodiment of the present invention, the automated medical matrix for diagnosing and scheduling patients may include customized modules and capabilities to provide treatment selection for obese weigh loss patients. The automated medical matrix for diagnosing and scheduling patients can be configured to include modules and capabilities to provide treatment selection for surgery patient candidates and can be configured to provide treatment selection for patient medication therapy and configured to coordinate automatically between all departments in a medical center using the present invention.

FIG. 1 shows a block diagram of an overview of an automated medical matrix for diagnosing and scheduling patients of one embodiment of the present invention. FIG. 1 shows an automated medical matrix for diagnosing and scheduling patients 100 configured to automate the processes of patient treatment selection based on the patient diagnosis, schedule and order the treatment and better coordinate scheduling between departments. The automated medical matrix for diagnosing and scheduling patients 100 can be configured to include a database software system 105 to record and store process modules and data. The database software system 105 can be configured to include one or more customized modules 110 of one embodiment of the present invention.

The one or more customized modules 110 can be configured to include a diagnostic cross reference module 120 to record patient diagnosis information and cross reference the diagnosis with treatments selected by medical personnel of a medical center. The one or more customized modules 110 can be configured to include an outcome scoring value matrix 140 to establish criteria and values to enable uniform assessment of the levels of effectiveness of treatments and procedures performed. The outcome scoring value matrix 140 values are assigned to all treatments and procedures performed in a medical center. The outcome scoring value matrix 140 values are assigned once the treatment is selection to reflect the expected or project outcome and after the treatment when the final outcome can be evaluated. An automated outcome results ranking system 160 can be configured to calculate the effectiveness of the treatment through a comparison of the projected and final outcome score values. The automated outcome results ranking system 160 stores the results in the diagnostic cross reference module 120 of one embodiment of the present invention.

The medical personnel can login to the automated medical matrix for diagnosing and scheduling patients 100 and enter the patient diagnosis into a treatment selection module 130. The treatment selection module 130 searches the database software system 105 information in the diagnostic cross reference module 120. The diagnostic cross reference module 120 transmits a list of treatments matching the diagnosis. The outcome scores from the automated outcome results ranking system 160 are ranked from highest score to lowest indicating the most effective treatment available to the least effective treatment. The treatment selection module 130 can be configured to perform two additional data searches of one embodiment of the present invention. The treatment selection module 130 can be configured to use an automated patient medical records search module 170 to search a patient's medical records to determine any matches with patient conditions such as allergies, respiratory or heart conditions that possible treatment side effects could increase patient risk and to determine any matches with patient conditions that would preclude use of the treatment selection. The treatment selection module 130 can be configured to use an automated patient insurance plan search module 180 to determine whether the treatment selected is one that is usually authorized by a patient insurance plan. The additional data search results for each treatment available is indicated on the list of one embodiment of the present invention.

When the medical personnel make a final treatment selection an automated treatment scheduling and order module 190 performs a search of the available appointment dates and times. The automated treatment scheduling and order module 190 selects the first available appointment and then proceeds to fill out the order forms for the treatment. Notices of the treatment appointment are automatically sent to the medical personnel making the treatment selection, the department where the treatment will take place and the patient. The automated medical matrix for diagnosing and scheduling patients 100 can reduce medical staff time to determine appropriate treatment selection, scheduling and ordering the treatment. The automated medical matrix for diagnosing and scheduling patients 100 provides up to date guidance to the medical personnel on potential treatment outcome results for the diagnosis as measured by both historical experience within the center and insurance plan acceptability of one embodiment of the present invention.

### Detailed Operation:

FIG. 2 shows a block diagram of an overview flow chart of an automated medical matrix for diagnosing and scheduling patients process and continues on FIG. 3 of one embodiment of the present invention. FIG. 2 shows medical personnel 200 logging on to the automated medical matrix for diagnosing and scheduling patients 100. The automated medical matrix for diagnosing and scheduling patients 100 automatically loads the outcome scoring value matrix 140. The outcome scoring value matrix 140 displays the matrix of outcome scoring values established to enable uniform assessment of the possible levels of effectiveness of treatments performed in the medical center of one embodiment of the present invention. The automated medical matrix for diagnosing and scheduling patients 100 retrieves from the database software system 105a selected treatment 210 chosen by the medical personnel 200. The automated medical matrix for diagnosing and scheduling patients 100 opens a projected outcome scoring module 220 in which the medical personnel 200 can enter an outcome scoring value based on the expected outcome of the selected treatment. The projected outcome scoring module 220 record the value assigned in the database software system 105 of one embodiment of the present invention.

After a treatment has been performed an automated post treatment assessment 230 sends a post treatment assessment reminder 240 to the medical personnel 200 that chose the selected treatment 210. The automated post treatment assessment 230 post treatment assessment reminder 240 instructs the medical personnel to open a final outcome scoring module 250 and enter the final outcome score value for the results of the treatment. The final outcome scoring module 250 records the final outcome score value in the database software system 105 of one embodiment of the present invention.

The automated medical matrix for diagnosing and scheduling patients 100 automatically searches for match pairs of projected outcome and final outcome score values. The automated medical matrix for diagnosing and scheduling patients 100 automatically uses an automated outcome results ranking system 160 to calculate the effective outcome results based on comparisons of projected and final outcome scores cross referenced to the corresponding diagnosis. The automated outcome results ranking system 160 records the calculated effective outcome results in the database software system 105 for use in processes that continue and are described in FIG. 3. The automated medical matrix for diagnosing and scheduling patients 100 processes to score and rank the effectiveness of treatments provides the medical personnel 200 with up to date guidance of the effective of treatment in use at their medical center to allow the medical personnel to make a more informed selection of treatments of one embodiment of the present invention.

### Treatment Selection Process:

FIG. 3 shows a block diagram of an overview flow chart continuing from FIG. 2 of an automated medical matrix for diagnosing and scheduling patients of one embodiment of the present invention. FIG. 3 shows the medical personnel 200 continuing the automated medical matrix for diagnosing and scheduling patients 100 of FIG. 1 wherein the medical personnel 200 make a treatment selection. The medical personnel 200 can proceed with patient diagnosis input 300. The patient diagnosis input 300 is recorded and stored in the diagnostic cross reference module 120. The diagnostic cross reference module 120 automatically creates a cross reference index for the diagnosis leaving the treatment information blank until a treatment is selected. The automated medical matrix for diagnosing and scheduling patients 100 of FIG. 1 opens the treatment selection module 130 which automatically using the automated outcome results ranking system 160 loads a treatment selection listing 310 for the diagnosis inputted of one embodiment of the present invention.

The treatment selection module 130 automatically proceeds with the automated patient medical records search module 170 performing a search to determine any matches with patient conditions such as allergies, respiratory or heart conditions that could increase patient risk due to listed possible side effects and to determine any matches with patient conditions that would preclude use of the treatment. The automated patient medical records search module 170 automatically annotates a treatment with either a patient medical records clearance report 320 or a patient medical records alert 330. The patient medical records alert 330 will display the patient condition that could increase patient risk and advise to reject use of the treatment of one embodiment of the present invention.

The treatment selection module 130 automatically proceeds with the automated patient insurance plan search module 180 performing a search of the patient insurance plan to determine whether a treatment listed is authorized for payment. The automated patient insurance plan search module 180 annotates a treatment with either an insurance plan pre-approval report 340 or an insurance plan non-approval report 350. The medical personnel 200 continue to make their final treatment selection of one embodiment of the present invention. The selected treatment, treatment outcome score and ranking and the search results from the automated patient medical records search module 170 and automated patient insurance plan search module 180 are recorded using a selected treatment annex module 360. The selected treatment annex module 360 stores information in the patient medical records to document the criteria used in the selection process of one embodiment of the present invention. The automated treatment scheduling and order module 190 continues the process for the selected treatment by searching the available appointment dates and times in the appropriate medical center departments 370 scheduling systems. An automated appointment booking module 380 secures the first available appointment and proceeds automatically to initiate processes in an automated treatment order preparation module 375. The automated treatment order preparation module 375 automatically prepares medical orders for the treatment selected. The automated treatment order preparation module 375 automatically fills in treatment order forms including the patient information, medical personnel ordering the treatment, appointment date and time and any other information requested on the form including the patient insurance plan treatment identification codes of one embodiment of the present invention.

The automated treatment order preparation module 375 automatically fills out the patient insurance plan request for pre-authorization for the treatment. The automated treatment order preparation module 375 further processes the request for either postal delivery or sends it electronically to the insurance carrier. The automated treatment order preparation module 375 will record any treatment approvals received from the insurance carrier electronically and any entry of the approval by medical center department personnel. Copies of the completed treatment order are automatically sent to the medical personnel 200 that selected the treatment, the medical center departments 370 involved in performing the treatment and the medical center billing department 390 for further processing once the treatment is performed of one embodiment of the present invention.

The automated appointment booking module 380 automatically sends the appointment information to the medical personnel selecting the treatment. The automated appointment booking module 380 automatically sends a patient appointment notice 385 to the patient using either a patient email address if listed in the patient medical records or hard copy of the patient appointment notice 385 using postal services of one embodiment of the present invention. The automated medical matrix for diagnosing and scheduling patients 100 can automatically process the vast amounts of information and treatment outcomes evaluations useful in determining the most effective treatment available. The automated medical matrix for diagnosing and scheduling patients 100 provides the most up to date guidance to medical personnel 200 in selecting a treatment for a specific patient including any indicated risk factors. The automated medical matrix for diagnosing and scheduling patients 100 automatically processes insurance approvals, appointment scheduling, treatment order preparation, notifications to all concerned and even prepares the billing for the treatment. All of these automated tasks would tie up medical personnel 200 staff time reducing their availability to perform other tasks for example face to face interaction with patients and duties electronic functions cannot perform. The use of the automated medical matrix for diagnosing and scheduling patients 100 in a medical center will save time, increase staff productivity, provide fast and accurate scheduling and coordination functions and allow medical personnel 200 to make more informed selections of available treatments of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. An automated medical matrix for diagnosing and scheduling patients to provide medical personnel with automated results presenting ranked treatment selections and automated treatment order scheduling, comprising:
a database software system configured record, store and retrieve data to create cross references of medical diagnoses and treatment outcomes and configured to record, store and operate programming modules;
one or more customized modules configured to perform programming operations to process cross referencing of medical diagnoses and treatment outcomes;
a diagnostic cross reference module to categorize diagnoses by type and create indexed references to treatments used in relationship to the diagnoses; an outcome scoring value matrix to establish criteria and values to enable uniform assessment of the levels of effectiveness of treatments performed;
an outcome results database module to record, store and retrieve data related to various medical treatments and the patient outcomes effected by the treatment use; an automated outcome results ranking system to calculate the effective outcome results based on comparisons of projected and final treatment outcome scores cross referenced to the corresponding diagnosis;
a treatment selection module configured to provide a listing of possible treatments ranked by the most effective outcome score results to the least effective outcome score results;
an automated patient medical records search module to search a patients medical records to determine any matches of patient conditions such as allergies, respiratory or heart conditions with possible treatment side effects;
an automated patient insurance plan search module to search for matches of treatments authorized by a patient insurance plan for a specific diagnosis; and;
an automated treatment scheduling and order module to search medical center department scheduling systems and book available treatment appointments and prepare the treatment order documents.

2. The system of claim 1, wherein the treatment selection module is configured to include a computer monitor displayed or hard copy listing of ranked treatment to include annotations of any patient risk factors and insurance carrier approvals.

3. The system of claim 1, wherein the outcome results database module is configured to record projected and final outcome scoring entries by cross reference to the corresponding diagnosis.

4. The system of claim 1, wherein the automated outcome results ranking system is configured to record the ranking treatment outcome scores by cross reference index with the corresponding diagnosis recorded in the diagnostic cross reference module.

5. The system of claim 1, wherein the automated treatment scheduling and order module is configured to include an automated treatment order preparation module to automatically fills in treatment order forms including the patient information, medical personnel ordering the treatment, appointment date and time and any other information requested on the form including the patient insurance plan treatment identification codes.

6. The automated treatment order preparation module of claim 5, wherein the automated treatment order preparation module is configured to record insurance carrier treatment approvals electronically.

7. The automated treatment order preparation module of claim 5, wherein the automated treatment order preparation module is configured to send copies of the completed treatment order automatically to the medical personnel, medical center departments and the medical center billing department.

8. The automated treatment order preparation module of claim 5, wherein the automated treatment order preparation module is configured to automatically fill out the patient insurance plan request for pre-authorization for the treatment and configured to automatically deliver the pre-authorization request to the insurance carrier by postal delivery or send it electronically.

9. The system of claim 1, wherein the automated treatment scheduling and order module is configured to include an automated appointment booking module to select and book the earliest treatment appointment available according the scheduling search.

10. The automated appointment booking module of claim 9, wherein the automated appointment booking module is configured to include the automatic preparation and transmittal of a scheduled treatment appointment notice to medical personnel, medical center departments and a patient.
